(19) United States
(12) Patent Application Publication
(10) Pub. No.: US 2022/0315410 A1
(43) Pub. Date: Oct. 6, 2022

(54) HORSE RELAXATION DEVICE

(71) Applicant: THINLINE, LLC, Durham, NC (US)

(72) Inventors: Elaine Lockhead CASTELAO, Durham, NC (US); Jason Asher BERNSTEIN, Alpharetta, GA (US)

(21) Appl. No.: 17/657,157

(22) Filed: Mar. 30, 2022

Related U.S. Application Data
(60) Provisional application No. 63/167,961, filed on Mar. 30, 2021.

(51) Int. Cl. B68B 1/06

(52) U.S. Cl. CPC B68B 1/06; B68B 2001/044

(57) ABSTRACT

A device for promoting relaxation of an animal includes a tubing member having a first end and a second end. At least one cord is coupled to the tubing member. Fasteners are coupled to ends of the at least one cord and are used to retain the device to the animal. The tubing member is configured to be placed in a mouth of the animal to promote chewing.

### PRIORITY CLAIM

This application claims priority under 35 U.S.C. § 119(e) to U.S. Provisional Application Ser. No. 63/167,961, filed Mar. 30, 2021, which is expressly incorporated by reference herein.

### FIELD

The present disclosure relates, in exemplary embodiments, to devices for inducing relaxation in horses. More particularly, the present disclosure relates, in exemplary embodiments, to devices for oral stimulation of equines, leading to relaxation and less fidgeting.

### BACKGROUND

Fidgeting, fretting and anxiety in horses and other animals can result in the animal biting, kicking, chewing on expensive reins, being less relaxed when being ridden, during farrier work, and the like. Jaw activation appears to result in relaxation of horses. Horses typically relax when they are chewing on something.

Conventional solutions for relaxing horses include tranquilizers, twitches, and lip chains. It would be desirable to have a drug-free, easy-to use device that would enable a horse to relax.

### SUMMARY

In accordance with the present disclosure, a device is configured to be worn by an animal and placed in the animals mouth to promote relaxation of the animal. The device includes a tubing member having a first end and a second end. The tubing member is configured to be placed in the mouth of the animal to induce the animal to chew on the device and relax as a result of the chewing.

In illustrative embodiments, the device further includes a first cord and a second cord each having a first end and a second end. The first end of the first cord is associated with the tubing member first end while the first end of the second cord is associated with the tubing member second end. The second ends of the cords are spaced apart from the tubing member.

In illustrative embodiments, the device further includes a first fastener associated with the second end of the first cord and a second fastener associated with the second end of the second cord. The first and second fasteners are configured to be attached to another structure worn by the animal, such as a halter or a bridle, to retain the device in place relative to the animal. In some embodiments, the device may also be used as a lip chain for a horse, for example.

In accordance with another aspect of the present disclosure, a device for promoting relaxation of an animal includes a hollow tubing member, a cord extending through the hollow tubing member, and first and second fasteners coupled to the cord. The hollow tubing member has a first length defined between a first end and a second end. The cord has a second length greater than the first length defined between a first end spaced apart from the first end of the hollow tubing member and a second end spaced apart from the second end of the tubing member. The first fastener is associated with the first end of the cord while the second fastener is associated with the second end of the cord.

### BRIEF DESCRIPTION OF THE DRAWINGS

The drawings disclose exemplary embodiments in which like reference characters designate the same or similar parts throughout the figures of which:

FIG. 1 is a top plan view of one exemplary embodiment of a device of the present disclosure configured to attach to a halter.

FIG. 2 is a side view in partial cutaway of the tubing and cord of the device of FIG. 1 showing one exemplary embodiment of a fastener.

FIG. 3 is a perspective view of a device of FIG. 1 attached to a horse.

FIG. 4 is a perspective view of a portion of a device of FIG. 1 shown attached to a horse and showing placement in the horse's mouth.

FIG. 5 is a schematic view of an alternative embodiment of a fastener adapted to slide along the cord and be removably clamped in place.

FIG. 6 is a schematic view of an alternative embodiment of a device having a single length of tubing passing through the tubing.

FIG. 7 is a top plan view of one exemplary embodiment of a device of the present disclosure configured to attach to a bridle.

FIG. 8 is a perspective view of the device of FIG. 7 shown attached to a horse and showing placement in the horse's mouth.

FIG. 9 is a perspective view of the device of FIG. 7 shown as worn by a horse in side view and showing placement in the horse's mouth.

FIG. 10 is a perspective view of the device of FIG. 7 shown attached to a horse in rear view and showing attachment behind the horse's jaw.

FIG. 11 is a top plan view of an alternative exemplary embodiment of a device configured for use as a lip chain

FIG. 12 is top plan view of a portion of the device of FIG. 11.

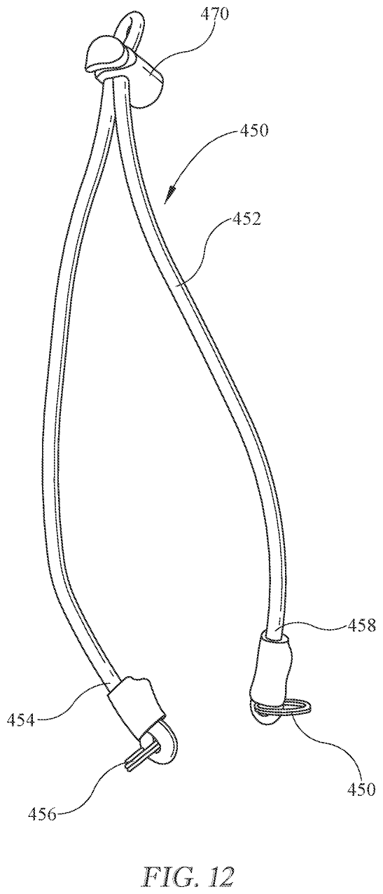

FIG. 13 is a perspective view of the device of FIG. 10 shown attached to a rope halter, as worn by a horse in side view.

FIG. 14 is a schematic view of an embodiment of a device having tubing with a plurality of apertures or slit formed therein.

FIG. 15 is a schematic view of an embodiment of a device having a remote controlled fluid dispensing assembly.

FIG. 16 is a schematic view of an embodiment of a device having a core tubing coated with a material.

FIG. 17 is a schematic view of an embodiment of a device having a solid material instead of the tubing.

### DETAILED DESCRIPTION

Unless otherwise indicated, the drawings are intended to be read (for example, cross-hatching, arrangement of parts, proportion, degree, or the like) together with the specification, and are to be considered a portion of the entire written description of this invention. As used in the following description, the terms “horizontal”, “vertical”, “left”, “right”, “up” and “down”, “upper” and “lower” as well as adjectival and adverbial derivatives thereof (for example, “horizontally”, “upwardly”, or the like), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

For the purposes of the present disclosure, the exemplary embodiments described herein are described for use with a horse 2 (as shown in various Figures), but use with other equines is contemplated as within the scope of the present disclosure, as well as other animals having suitable jaw structures. In exemplary embodiments, the devices of the present disclosure can be attached to a halter 4. In other exemplary embodiments, the devices of the present disclosure can be attached to a bridle 6.

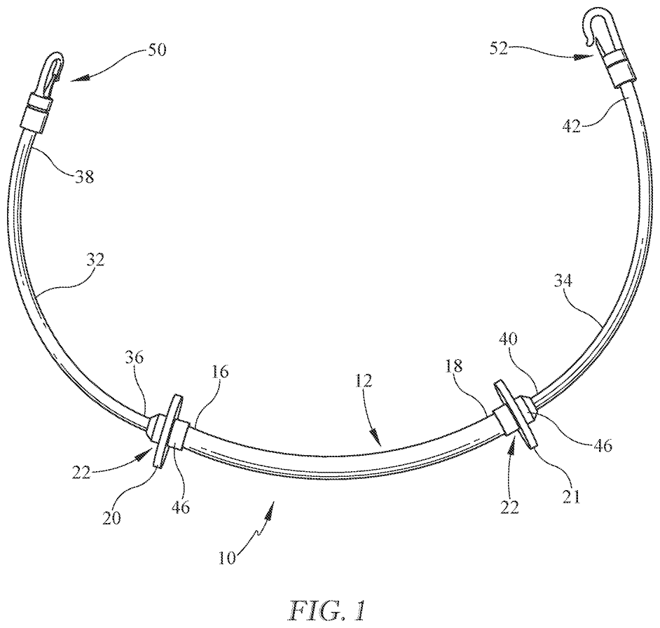

FIG. 1 shows a first exemplary embodiment of a relaxation device 10 configured for attachment to a halter 4 (as shown in various other Figures). The device 10 may comprises a length of tubing 12. In exemplary embodiments the tubing 12 is hollow. Alternatively, the tubing 12 can be solid. In exemplary embodiments the tubing 12 is deformable. In exemplary embodiments the tubing 12 may be made of latex. In exemplary embodiments the tubing 12 may be made of food-grade biodegradable latex, The tubing 12 is desirably made of material which is biologically inert and does not cause an adverse (e.g., allergenic or sensitivity) reaction when in a horse's mouth.

The tubing 12 has a first end 16 and second end 18. In one exemplary embodiment, at least one (and, in exemplary embodiments, disks 20 and 21) disk 20 has an aperture 22 formed therein and can function as a bit guard. In exemplary embodiments the disk 20 can have a generally circular cross-sectional shape, or it can have a torus, spherical, semi-spherical, ovoid, or other regular or irregular cross-sectional shape. In exemplary embodiments, the disk 20 can be made of a flexible, deformable, or soft material and may be nonreactive when disposed proximate to the horse's mouth. In exemplary embodiments, the disk 20 may be made of ThinLine™ open-cell foam material (available from ThinLine Global, Durham, N.C.). In other exemplary embodiments, the disk 20 is not used. The tubing 12 can be inserted in the aperture of the disks 20, 21.

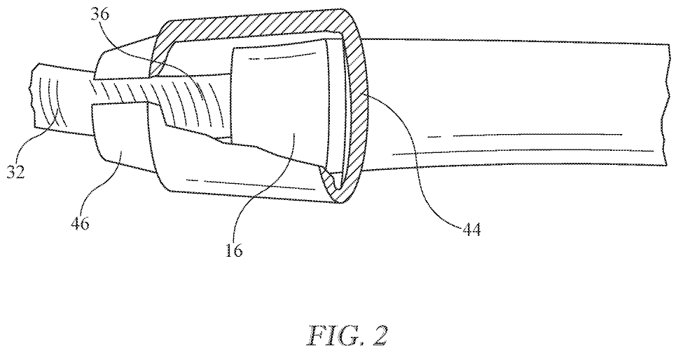

FIG. 2 shows an exemplary embodiment in which an attachment cord 30 comprising two pieces is attached to the tubing 12. In one exemplary embodiment, the cord 30 comprises a first cord 32 and a second cord 34. The first cord 34 has a first end 36 and a second end 38. The second cord has a first end 40 and a second end 42. In exemplary embodiments, the cord 30 is elastic or has at least a portion thereof being elastic. In other exemplary embodiments, the cord 30 is relatively inelastic. In one exemplary embodiment, the first cord first end 36 is inserted into the tubing 12, as shown in FIG. 2, and maintained in place by a fastener 44, such as, but not limited to, a staple, clip, crimpable wire, or other fastening means. Alternatively, the first cord first end 36 may be maintained in place by a nonreactive adhesive. In one exemplary embodiment, shown in FIG. 2, a shield 46, such as a heat-shrinkable material, may be utilized to cover the first cord first end 36, tubing first end 16 and fastener 44 so as to prevent contact with and irritation of the horse.

In exemplary embodiments where disks 20, 21 are utilized, the disk 20 may be slid over the first cord 32 and positioned proximate to the first end 16 of the tubing 12, and the disk 21 may be slid over the second cord 42 and positioned proximate to the second end 18 of the tubing 12.

In exemplary embodiments where a first cord 32 and second cord 34 are utilized, a fastening means is associated with the first cord second end 38. In exemplary embodiments, the fastening means may comprise a hook-type clip 50. In exemplary embodiments the fastening means may comprise a carabiner, hook, snap, hook and loop combination, or other fastening means. Similarly, a fastening means, such as a clip 52 (or other fastening means similar to that described with respect to the clip 50), is associated with the second end 42 of the second cord 34.

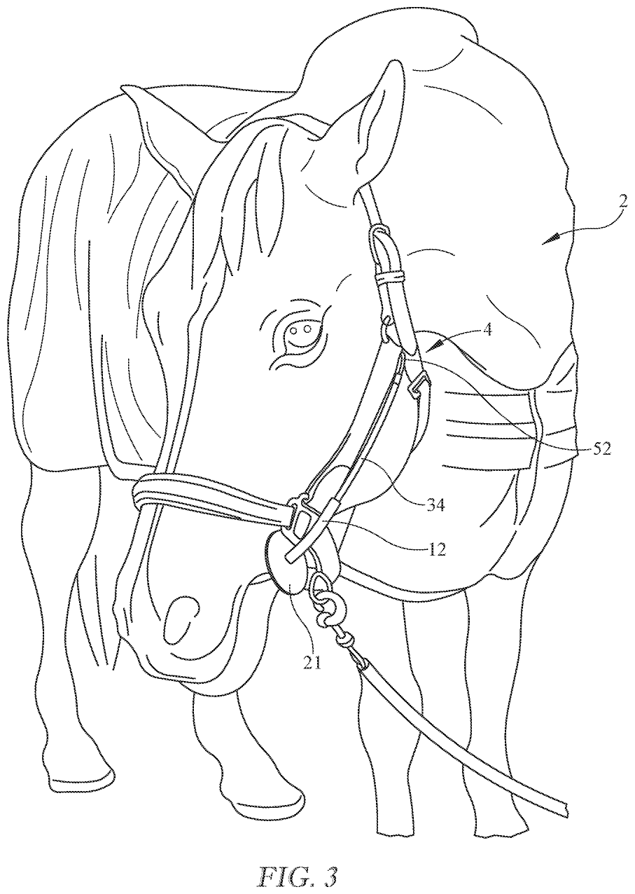

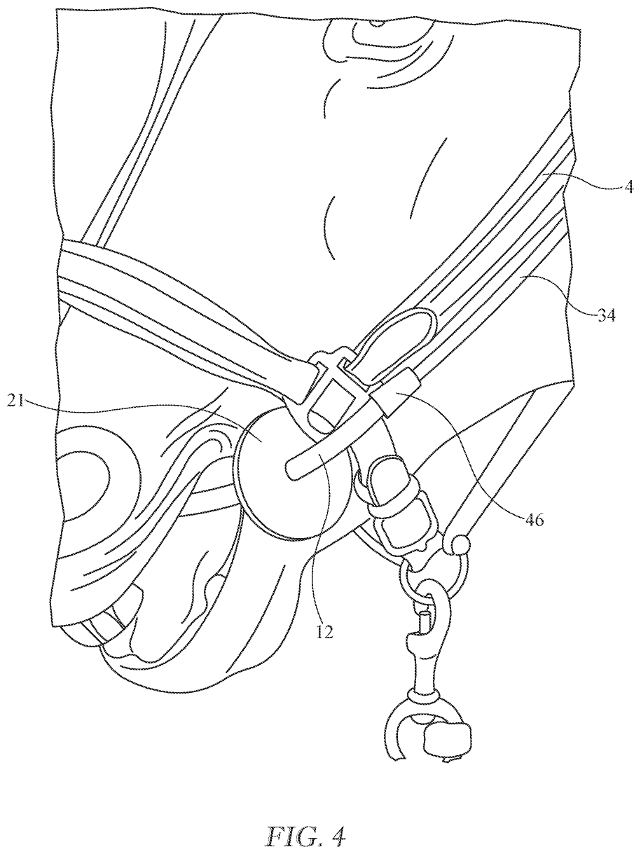

In exemplary embodiments, shown in FIGS. 3-4, the device 10 can be removably attached to both sides of a halter 4 by the attaching the clip 50 to a halter top ring 54 (shown in FIG. 4) and the clip 52 to a top ring (not shown) on the other side of the halter 4. The tubing 12 is positioned in the back of the horse's mouth and the disks 20, 21, if utilized, are positioned outside of and on each side of the horse's mouth. The first cord 32 and second cord 34 are advantageously made of an elastic material so that the device 10 can be fitted to the horse in a comfortable manner. The device 10 (and other embodiments thereof) should fit loosely in the horse's mouth. It should not pull the corners of the mouth. The tubing 12 stimulates jaw activation, which can result in relaxation of the horse. The overall length of the device 10 can be modified by removing the first and second clips 50, 52 and cutting a portion of the first cord 32 and/or second cord 34 to the appropriate length, and then reattaching the clips 50, 52.

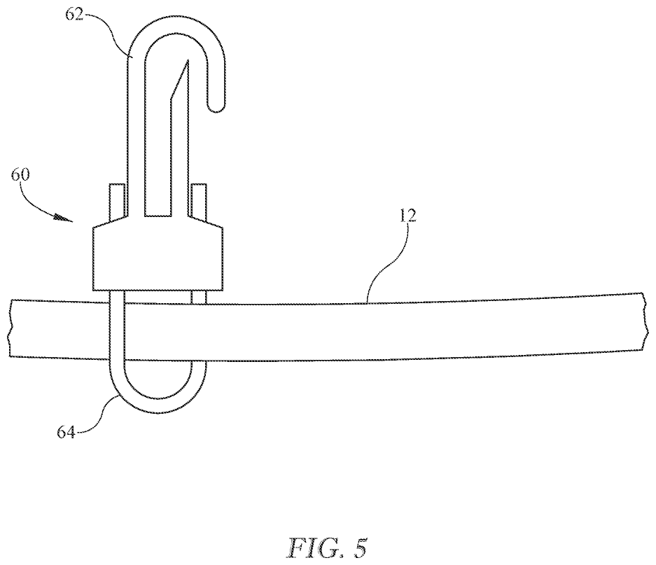

FIG. 5 shows an alternative exemplary embodiment of a slidingly positionable fastener 60, which comprises a clip 62 (similar to the clip 50) adapted to attach to the halter 4, and an adjustable second fastening member, such as, but not limited to, a removable fixation means, such as, but not limited to, a clamping or clipping means, such as clamp 64 that can adjustably slide along at least a portion of the cord 32 and removably clamped or fixed to be maintained in place, with the user unclamping or unfixing the clamp 64 when adjustment is needed. A similar fastener 70 can be associated with the second cord second end 42. This exemplary embodiment allows for adjustment of the device 10 without having to remove part of the cord 32. This exemplary embodiment also enables replacement of cord 30 without having to replace the fastener 60.

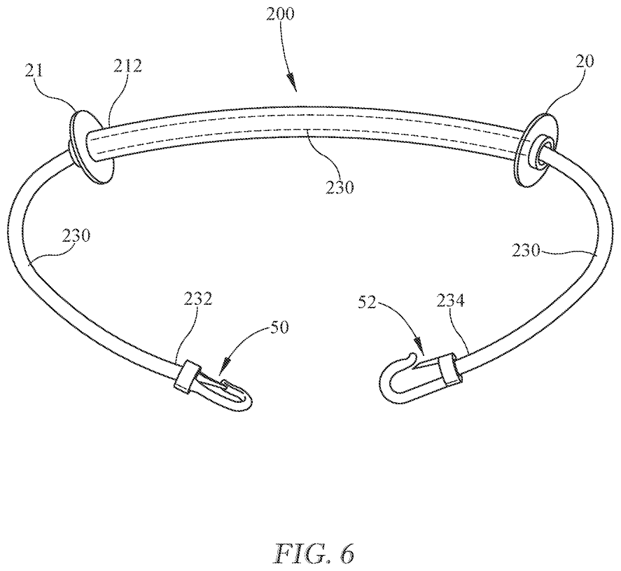

FIG. 6 shows an alternative embodiment of a device 200 having a single-cord variation, and includes hollow tubing 212 and a single cord 230 that extends through hollow tubing 212, rather than two pieces of cord. As with the device 10, a fastener 44 is attached to a first end 232 of the cord 230 and a second fastener 44 is attached to a second end 234 of the cord 230. Similar to the device 10 embodiments, where disks 20 and/or 21 are utilized, they can be slid over and positioned on the tubing 212.

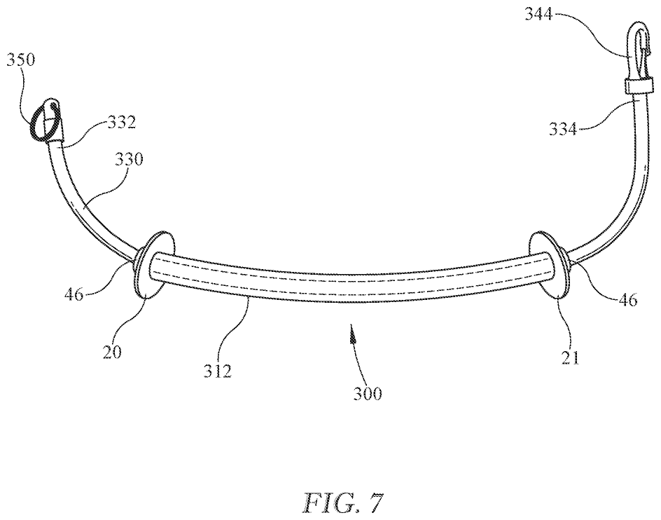

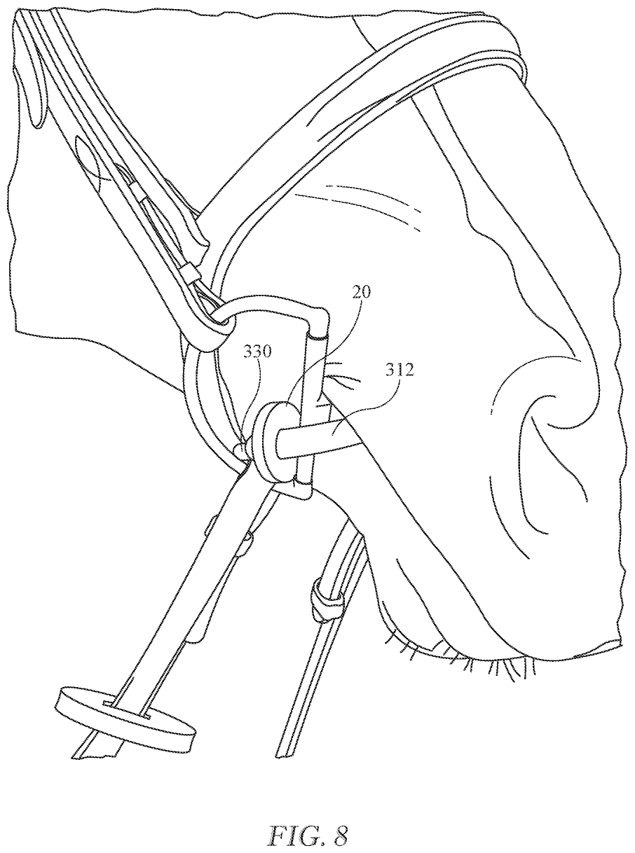

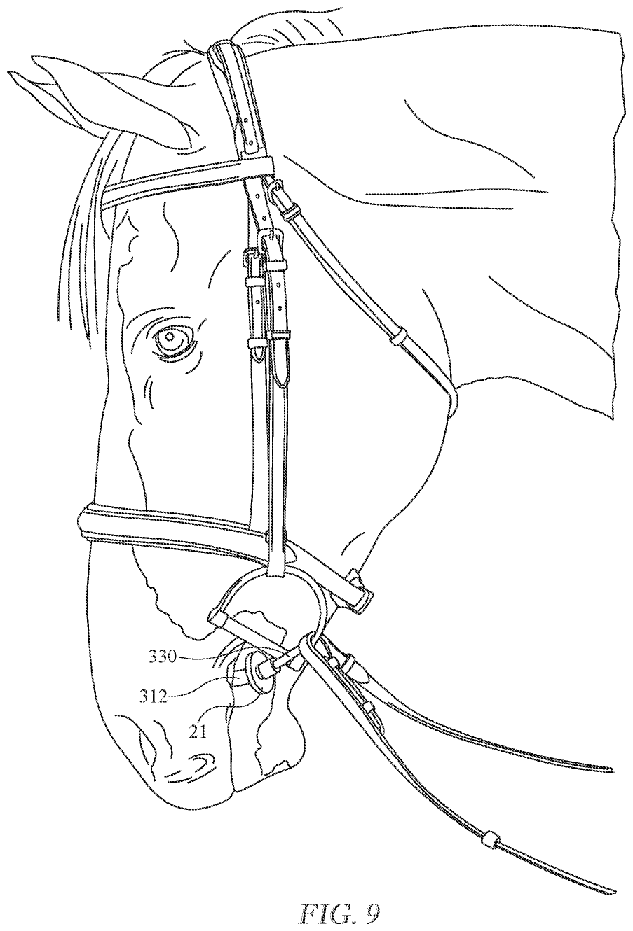

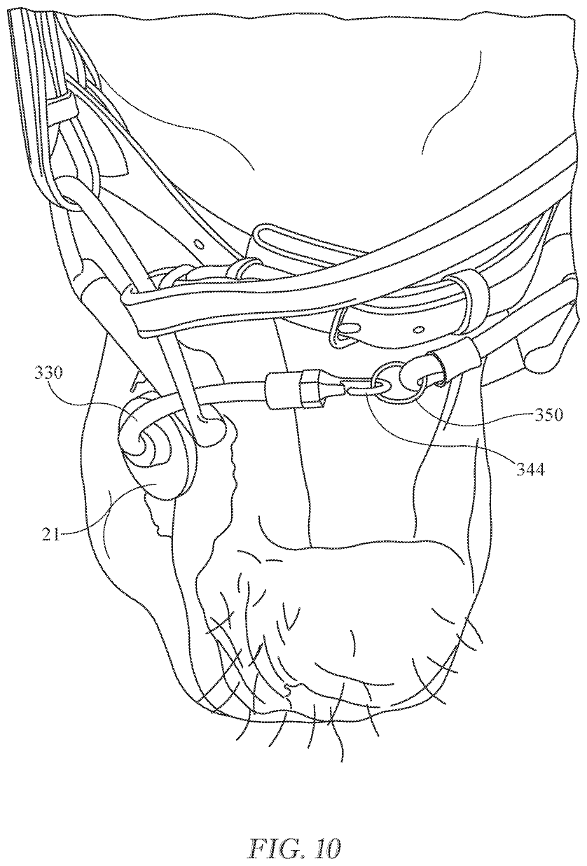

FIG. 7 shows an exemplary embodiment of a device 300 adapted to be attached to a bridle 6, rather than the halter 4. Device 300 may have tubing 312 and cord 330 (with first end 332 and second end 333) (and variations of each), as described herein with respect to other embodiments), but rather than having a clip 50 associated with each end of the cord 30, has a clip 344 (or other fastening means) associated with the cord first end 332, and has an attachment member 350 to which the clip 344 can be removably associated. The attachment member 350 can be a ring, or it can be a fastener similar to fastener 344. The fastener 344 removably attaches to the attachment member 350. In this embodiment the device 300 may have a single length of cord 330 inserted through the tubing 312 (similar to device 200), or, may have two cords, similar to the exemplary embodiment of device 10. Also, disks 20, 21, may be utilized. FIGS. 8-10 show various views of the device 300 fitted to a horse 2 by being inserted through the two D-rings 360, 362 of the bridle 6 and the fastener 344 engaged with the attachment member 350. In this embodiment, the device 300 has the cord 340 and 360 disposed outside of the mouth and beneath the horse's lower jaw so that the tubing 312 is positioned in the back of the mouth.

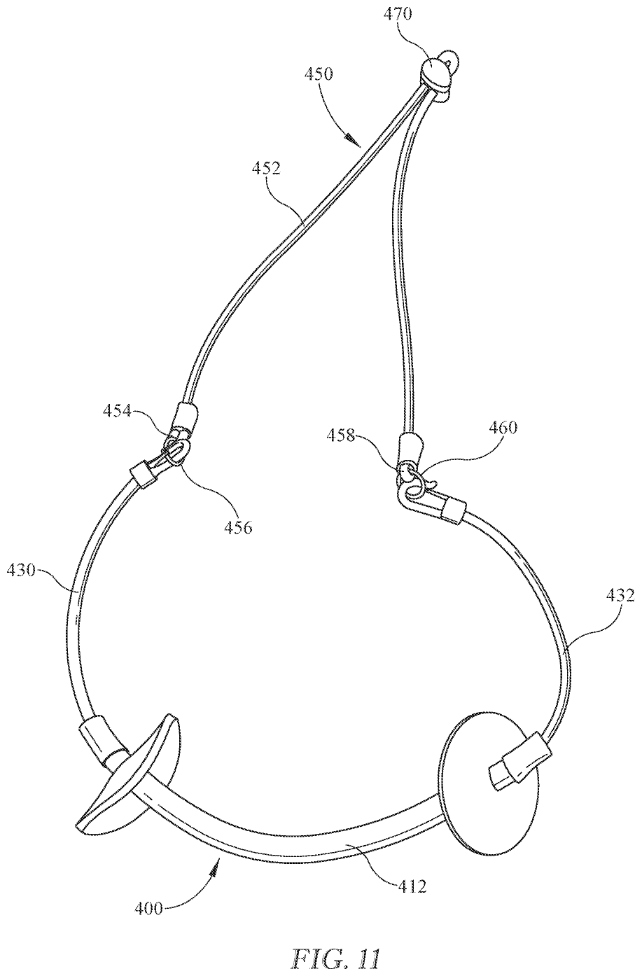

FIG. 11 shows an exemplary embodiment of a device 400 adapted for use as a lip chain. A lip chain just gives the handler an advantage while handling the horse. A lip chain is placed along the upper gum line in a horse's mouth and attaches to the lead rope. While using a lip chain, a fair amount of pressure is maintained so that the chain does not slip off of the horse's gums and into its mouth, but, when used correctly, does not cause the horse discomfort. Device 400 has, similar to device 10, tubing 412, and first cord 430 and second cord 432 (it being understood that the cord may be a single cord as described with respect to device 200). The first cord 430 has an end 434 has a fastener 440 associated therewith, the fastener 440 being any of the fasteners described herein with respect to that being associated with an end of the cord 30 (or 32, 34, depending on the embodiment). The second cord 432 has an end 436 and has a fastener 444 (similar to fastener 440) associated therewith.

A strap 450 comprises a length of cord 452 having a first end 454 with an attachment member 456 associated therewith, and a second end 458 having an attachment member 460 associated therewith. Strap 450 may optionally further include an adjustment member 470, which may comprise a ring, clamp, clip, or other fastening means slidingly associated with the cord 452 and which allows for the user to adjust the effective available length of the cord 452 when fitted to the horse 2. In exemplary embodiments, the strap 450 is attached at end 454 to the fastener 440 and at end 456 to the fastener 444.

The device 400 is fitted to the horse 2 by inserting the tubing 412 above the horse's front teeth and between the teeth and top lip, rather than in the mouth. The strap 450 can be fitted behind the horse's head, just below the ears, so as to promote the tubing 412 remaining in position and not sliding down behind or below the teeth into the horse's mouth (i.e., not over the tongue).

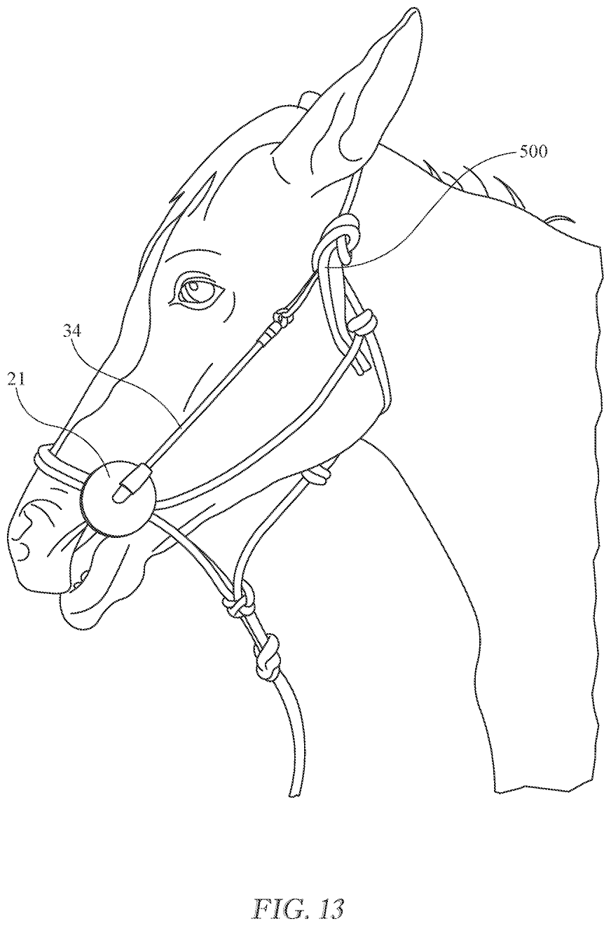

FIG. 13 shows an exemplary embodiment of a device 10, adapted for use as a lip chain, with the device 10 attached to either side of a rope halter 500.

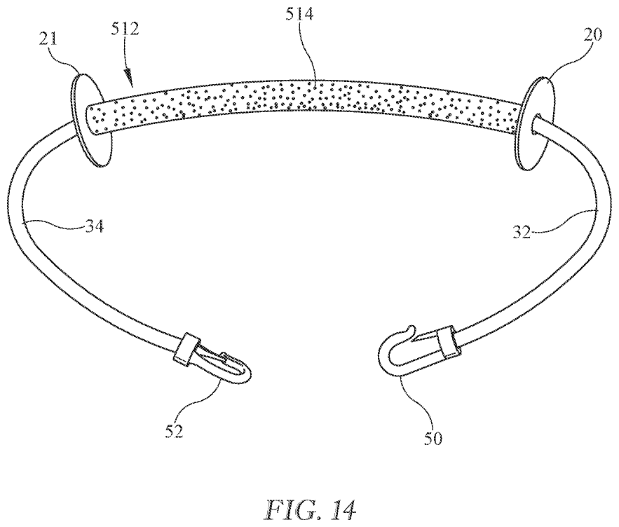

Hollow or filled tubing can be used in various situations to deliver materials over time to the horse's mouth. In various exemplary embodiments of the tubing described hereinabove, tubing 512 (and various alternative embodiments described herein) is hollow, and, as shown in FIG. 14, can have at least one aperture 514, and preferably a plurality of apertures 514 formed in the tubing wall. The tubing 512 can be at least partially filled with a fluid, particles, or other material 516 (not shown), which can serve any of a variety of purposes, including, but not limited to, helping to calm or relax the horse, promote chewing activity, deliver nutrients or medicine, or the like. Alternatively (or in addition to the apertures 514), the tubing 512 can be at least partially filled with a sponge-like or otherwise absorbent material 520 (not shown). Alternatively, the tubing 512 is at least partially porous or fluid permeable so as to permit fluid or other material to pass (e.g., by dissolving or as the result of the tubing being compressed by the chewing or masticating (or otherwise movement of the jaws) of the horse) from inside the tubing 512 outward and into the horse's mouth. The tubing 512 can have apertures, perforations, slits, or the like which can be constructed in one or more diameters or widths, in different configurations, special arrangements, or arrays, and in different numbers, as desired in order to optimize the rate of release of fluid or other material into the horse's mouth.

In an alternative exemplary embodiment, the tubing 512 can be injected with a fluid, such as, but not limited to, a liquid, gel, gas, aerosol, or other flowable material. In exemplary embodiments, the fluid can be a flavoring (such as, but not limited to, mint, apple, sweetened fluid, or the like). In other exemplary embodiments, the fluid can contain nutrients, medicine, or bioactive material.

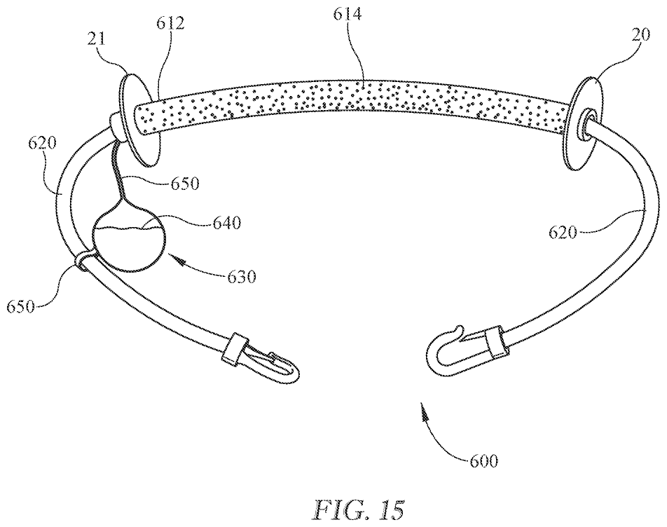

FIG. 15 shows an exemplary embodiment of a device 600 including a means for dispensing fluid from a reservoir. In this embodiment device 600 has tubing 612 with apertures 614 (or slits, pores, or the like), cord(s) 620, and a fluid reservoir 630, such as, but not limited to, a bulb, can be connected to the tubing 612 by a conduit 640. The reservoir 630 can be filled with a fluid 640 which an operator can dispense into the tubing 612 via the conduit 640 when desired (i.e. by squeezing reservoir 630). The reservoir 630 can be associated with the cord 620 by a retention member 650 or retained on the halter 2 or other location.

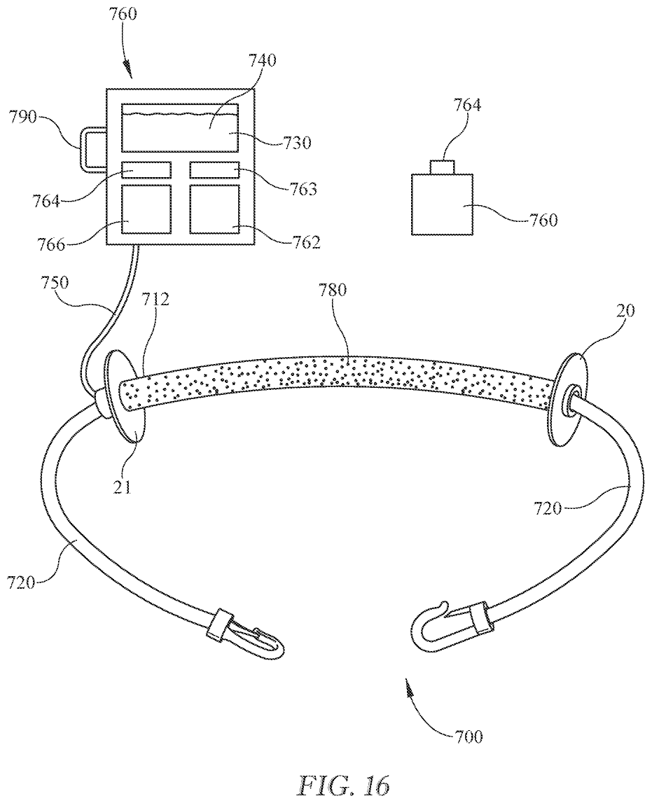

FIG. 16 shows an exemplary embodiment of a device 700 including a remotely controllable dispensing system dispensing fluid from a reservoir. A device 700 with a tubing 712, cord 720, includes comprises a reservoir 730 which holds fluid 740, and a conduit 750. The device 700 further comprises a dispensing system 760, which includes motor 762 which can pump fluid 740 from the reservoir 730 through the conduit 750 and into the tubing 712 so that it can enter the tubing 712. The dispensing assembly 760 can have a battery 763 and a remotely actuatable switch 764, such as, but not limited to, a solenoid which is operably connected to a receiver 766. A remote actuator, such as a transmitter 760 controlled by the user, can send a signal to the receiver 766 to actuate the switch 764, which actuates motor 762 remotely. Thus, remote dispensing of fluid 740 can be achieved at or over a desired time. For example, a drug or nutrients can be dispensed into the horse's mouth remotely at any time through apertures 780 in the tubing 712 by actuating the transmitter 760 to send a signal to the receiver 766 the dispensing assembly 760. The dispensing assembly can be retained on the halter via a retention member 790. This feature can enable the horse's owner, trainer or the like to avoid entering the horse's stall or having to give the horse medicine by feeding or injection.

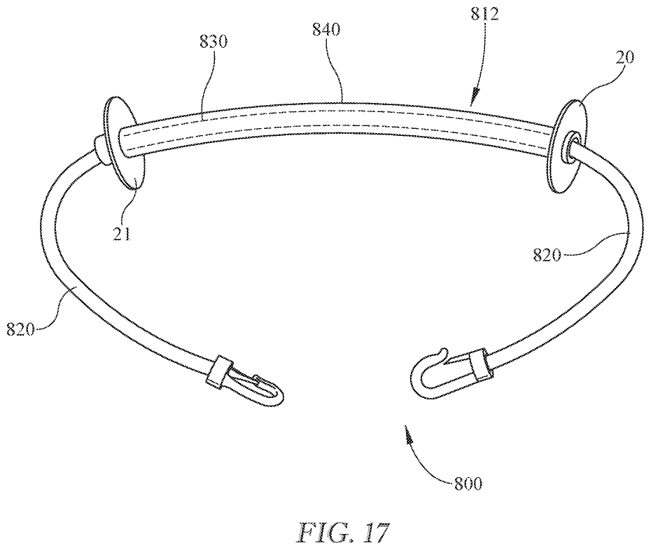

FIG. 17 shows an alternative exemplary embodiment of a device 800, which, rather than having tubing, has a length of long-lasting semi-hard (not hard enough to irritate the skin around the mouth) material 812, such as, but not limited to, jerky, hide, or other natural edible material that the horse can chew on (or masticate at the gum area) for an extended period of time before it dissolves or wears away. To each end 814, 816 of the material 812 is attached a cord 820. Alternatively, the material 812 can be a core 830 of non-degradable material (e.g., hollow tubing as described hereinabove) coated with a coating 840 of degradable or dissolvable material.

Each of the embodiments described hereinabove may optionally utilize the disks 20, 21. It is to be understood that in certain circumstances only one disk 20 may be used, on one side of the horse's mouth.

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

As used in the specification and the appended claims the singular forms “a,” “an”, and “the” include plural referents unless the context clearly dictates otherwise.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods, equipment and systems. These and other components are disclosed herein, and it is understood that when combinations, subsets, interactions, groups, etc., of these components are disclosed that while specific reference of each various individual and collective combinations and permutation of these may not be explicitly disclosed, each is specifically contemplated and described herein, for all methods, equipment and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

It should further be noted that any patents, applications and publications referred to herein are incorporated by reference in their entirety.

What is claimed is:

1. A device for promoting relaxation of an animal, comprising:
a) a tubing member having a first end and a second end, the tubing member configured to be placed in the mouth of the animal;
b) a first cord having a first end and a second end, the first end being associated with the tubing member first end;
c) a second cord having a first end and a second end, the first end being associated with the tubing member second end;
d) a first fastener associated with the second end of the first cord; and
e) a second fastener associated with the second end of the second cord.

2. The device of claim 1, further comprising a first disk coupled to the first end of the tubing member and a second disk coupled to the second end of the tubing member.

3. The device of claim 2, wherein the first disk and the second disk have a circular shape and a greater diameter than the tubing member.

4. The device of claim 1, wherein the first fastener and the second fastener are each hook-type clips and the device is configured to be attached removably to a halter.

5. The device of claim 4, wherein at least one of the first fastener and the second fastener includes a clamp coupled to the hook-type clip and wherein the clamp is adjustable along one of the first cord and the second cord.

6. The device of claim 1, wherein the tubing member is hollow and deformable.

7. The device of claim 6, wherein the first end of the first cord and the first end of the second cord extend at least partially into the tubing member.

8. The device of claim 1, wherein the first fastener is a removable clip and the second fastener is an attachment member, and wherein the removable clip is configured to be attached to the attachment member after the first cord and the second cord pass through corresponding openings formed in a bridle to attach the device to the bridle.

9. The device of claim 1, further comprising a strap including a length of cord, a first attachment member coupled to a first end of the length of cord, and a second attachment member coupled to an opposite, second end of the length of cord, and wherein the first attachment member is configured to be attached to the first fastener and the second attachment member is configured to be attached to the second fastener.

10. The device of claim 9, wherein the strap further comprises an adjustment member coupled to the length of cord between the first attachment member and the second attachment member.

11. The device of claim 1, wherein the tubing member is hollow to define an interior space and the tubing member is formed to include at least one aperture that opens into the interior space, and wherein the interior space is configured to be filed with particles that are configured to be distributed from the interior space, through the at least one aperture, to a mouth of the animal.

12. The device of claim 11, wherein the particles include at least one of flavoring, nutrients, and medicine.

13. The device of claim 11, further comprising a reservoir coupled to the tubing member by a conduit and configured to retain the particles for distribution to the interior space through the conduit.

14. The device of claim 13, further comprising a dispensing system including a motor configured to pump the particles from the reservoir through the conduit to the interior space of the tubing member.

15. The device of claim 14, wherein the dispensing system further includes a battery and a remotely actuatable switch that, when actuated, causes electrical power to be transferred from the battery to the motor to operate the motor.

16. The device of claim 1, wherein the tubing member includes a length of edible material that is configured to be consumed by the animal.

17. The device of claim 16, wherein the tubing member further includes a core of non-degradable material and the length of edible material forms a coating around the core of non-degradable material.

18. A device for promoting relaxation of an animal, comprising:
a) a hollow tubing member having a first length defined between a first end and a second end, the hollow tubing member configured to be placed in the mouth of the animal;
b) a cord extending through the hollow tubing member and having a second length greater than the first length defined between a first end spaced apart from the first end of the hollow tubing member and a second end spaced apart from the second end of the tubing member;
c) a first fastener associated with the first end of the cord; and
d) a second fastener associated with the second end of the cord.

19. The device of claim 18, further comprising a first disk coupled to the first end of the tubing member and a second disk coupled to the second end of the tubing member, and wherein the first disk and the second disk have a circular shape and a greater diameter than the tubing member.

20. The device of claim 18, wherein the first fastener and the second fastener are each hook-type clips and the device is configured to be attached removably to a halter, and wherein at least one of the first fastener and the second fastener includes a clip and a clamp and wherein the clamp is adjustable along one of the first cord and the second cord.
